(19) United States
(12) Patent Application Publication
(10) Pub. No.: US 2019/0295540 A1
(43) Pub. Date: Sep. 26, 2019

(54) VOICE TRIGGER VALIDATOR

(71) Applicant: Cirrus Logic International Semiconductor Ltd., Edinburgh (GB)

(72) Inventor: Steven Evan GRIMA, Newbury (GB)

(73) Assignee: Cirrus Logic International Semiconductor Ltd., Edinburgh (GB)

(21) Appl. No.: 15/934,092

(22) Filed: Mar. 23, 2018

(51) Int. Cl. G10L 15/22; G10L 15/08; G10L 15/02

(52) U.S. Cl. CPC G10L 15/22; G10L 15/08; G10L 2015/223; G10L 2015/088; G10L 15/02

(57) ABSTRACT

The present disclosure provides an audio signal processing circuit for receiving an input signal derived from sound sensed by an acoustic sensor, the audio signal processing circuit comprising: a trigger phrase detection module for monitoring the input signal for at least one feature of a trigger phrase and outputting a trigger signal if one said feature is detected; wherein the trigger signal is ignored if a time interval between an occurrence of the at least one feature and an occurrence of a feature indicative of a start of speech contained in the input signal is greater than a threshold amount of time. The present disclosure further provides a voice trigger validator comprising: a determination module operable to determine a time period between a voice trigger event and a start-of-speech event; wherein, when the time period exceeds a predetermined threshold, the voice trigger event is invalidated as a voice trigger and, when the time period does not exceed the predetermined threshold, the voice trigger event is validated as a voice trigger. The present disclosure still further provides a voice trigger validation method.

### TECHNICAL FIELD

The present disclosure relates to a voice trigger validator, and in particular to a voice trigger validator for use in devices having a voice-activation function.

### BACKGROUND

Devices having a voice-activation function may be provided with functional units and/or circuitry which are able to continually listen for voice commands, while in stand-by mode. This removes the requirement for a button or other mechanical trigger to ‘wake up’ the device from stand-by mode, for instance to activate otherwise inactive or idle functions. This allows such devices to remain in a low power consumption mode until a key phrase or voice command is detected, at which point functional units and/or circuitry having additional/higher power consumption may be activated.

Voice trigger technology typically uses a particular voice command to activate a given device and/or specific functions, once the voice command is detected. In this context the device may include an always on (ALON) idle or standby mode, in which most of the functionality of the device is deactivated except for a command detector. Once the relevant voice command is detected, the idling or deactivated functional units and/or circuitry may be reactivated, i.e. ‘woken up’.

One example of a possible way of initiating full use of a commercial product, such as a mobile telephone, is for the user of the phone to say a key phrase, for example “Hello phone”. The device is provided with functionality for recognising that the key phrase has been spoken and is then operable to “wake up” at least one speech recognition functional unit and/or circuitry and potentially the rest of the device.

### Problem

Existing voice trigger technology suffers from a problem that some sounds or speech are accepted erroneously as the voice trigger, resulting in a “false positive” detection of a voice trigger. It is therefore desirable to reduce the number of erroneous voice triggers.

### Statements

According to an example of a first aspect there is provided an audio signal processing circuit, module or functional unit, or audio signal processor, for receiving an input signal. The input signal may be derived from sound sensed by an acoustic sensor. The audio signal processing circuit comprises a trigger phrase detection module, functional unit or circuit, or trigger phrase detector, for monitoring the input signal for at least one feature, characteristic, parameter or the like of a trigger phrase. The trigger phrase detection module is further operable to output a trigger signal if one said feature is detected. The trigger signal may be ignored if a time interval between an occurrence of the at least one feature and an occurrence of a feature indicative of a start of speech contained in the input signal is greater than a threshold amount of time.

In accordance with the above described example the audio signal processing circuit may receive the input signal, which is a signal output from an acoustic sensor, such as a microphone. The input signal may be received, at the audio signal processing circuit, in the form of a stream of data representative of real time speech sensed by the acoustic sensor. In other words, the input signal may be derived from the sound sensed by the acoustic sensor. The sound may for example include one or more voices, producing specific voice patterns, or may be any detectable sound in the vicinity of the acoustic sensor. The trigger phrase detection module (trigger phrase detector) is operable to monitor the incoming input signal for at least one feature, characteristic, parameter or the like of a trigger phrase. A trigger phrase may for example be a word or sound, known in advance to the trigger phrase detection module as a command to activate idle functions of a device, such as a commercial product. A trigger phrase detection module may detect any feature of a trigger phrase. Such a feature may include a sound or a part of a word recognisable as a likely element of a trigger phrase. The trigger phrase detection module is then operable to output a trigger signal if one of the known features is detected. In other words, if the trigger phrase detection module detects any part of a trigger phrase, a trigger signal may be output.

According to one or more examples of the present aspects, it is then determined if a time interval between an occurrence of the at least one characteristic, parameter or feature and the like of a trigger phrase and an occurrence of a feature indicative of a start of speech contained in the input signal is greater than a threshold amount of time. If the time interval is greater than the threshold, the trigger signal may be ignored for the purpose of triggering the activation of otherwise idling or inactive functions. For example, the trigger signal may no longer be recognised as a command to activate said functions. It will be appreciated that the feature indicative of a start of speech contained in the input signal may represent the time at which a given user starts to speak.

If the time interval between the occurrence of the at least one feature of the trigger phrase and the occurrence of a feature indicative of a start of speech contained in the input signal is smaller than or equal to the threshold amount of time, the trigger signal is not ignored, and may for example be output to a command unit or controller to control activation of the otherwise idling or inactive functions of the device. For example, the trigger phrase may simply be forwarded, or a separate command signal based on the trigger signal may be output, to instruct activation of said functions. In an example, the occurrence of at least one feature, characteristic, parameter or the like of a start of speech may be determined either before or after the occurrence of at least one feature, characteristic, parameter or the like of a trigger phrase. The processing time taken to determine that a feature indicative of a start of speech has occurred may be longer than the processing time taken to determine that a feature of a trigger phrase has occurred. This difference in processing time may be taken into account when setting the threshold amount of time.

The threshold amount of time may for example be between 100-200 milliseconds or any amount up to a few seconds, e.g. 1-3 seconds, or may be based on a number of spoken words (for example the average time taken to say one, two or three words). The predetermined threshold may be based on user input.

Further, in an example, the trigger signal is not ignored if the time interval between the occurrence of the at least one feature and the occurrence of the feature indicative of a start of speech contained in the input signal is smaller in length than or equal in length to a threshold amount of time. The characteristic of a trigger phrase may include at least a part of a predetermined voice trigger word, phrase or sound. According to an example the audio signal processing circuit further comprises a start of speech detection module operable to detect the feature indicative of a start of speech, based on speech patterns in the input signal.

According to an example of a second aspect there is provided a voice trigger validator. The voice trigger validator comprises a determination module for determining a time period between a voice trigger event and a start-of-speech event. When the time period exceeds a predetermined threshold, the voice trigger event may be invalidated or ignored as a voice trigger. When the time period does not exceed the predetermined threshold, the voice trigger event may be validated or accepted as a voice trigger.

User preference indicates that voice triggers tend to be used at the start of the sentence or when a person starts talking. This may in part be due to a user preference to ensure the device being spoken to is listening, or may be due to existing programming, which traditionally encourages the user to begin speaking to voice-activated devices by saying a trigger phrase. Therefore, according to one or more of the present examples, a trigger occurring anywhere except at or near the start of speech is deemed not to be a valid trigger. This is achieved, according to example embodiments, by setting a predetermined threshold after which a voice trigger is ignored. For example, after a specific amount of time the occurrence of any subsequent part or feature of a voice command or voice trigger phrase is deemed to be invalid and is disregarded. Therefore, if a voice command is disregarded in this way, further functions of the device are not activated.

The predetermined threshold may be considered to be a maximum amount of time between a detected start-of-speech, i.e. a time when speech is detected or a time when a specific voice is detected, and a detected voice trigger. In accordance with one or more examples, false voice triggers can be eliminated based on the time interval between when a person starts speaking and when the feature of the trigger is determined by the audio processing circuit to have occurred. Thus, the number of false triggers may be reduced.

Optionally, according to an example the voice trigger validator may further comprise a buffer for storing a predetermined amount of data derived from sound received by a sound detector. Upon detection of the voice trigger event as received sound, the stored data may be searched to determine whether a start-of-speech event was detected.

In accordance with an example a buffer may be provided, wherein the buffer is configured to store a specific amount of data derived from detected sound. For example, the buffer may take the form of a circular buffer having an area of memory to which data is written, with that data being overwritten when the memory is full. The buffer may be configured to receive a data signal derived from the acoustic sensor as a stream and to store a predetermined number of samples of the acoustic data, wherein the number of stored data samples corresponds to an interval of time. For example, the buffer may be configured to store a data samples derived from the acoustic sensor corresponding to an interval of time, e.g. 5 to 15 seconds, which may correspond to the most recently derived data samples. According to one example, upon detection of a voice trigger event, the data stored in the buffer and thus corresponding to the predetermined interval of time may be searched for a feature which is indicative of a start-of-speech event. In a further example, and following detection of a voice trigger event, data corresponding to only a portion of the time interval (e.g. 3-5 seconds) is searched, wherein the portion may correspond to e.g. the most recently detected samples. It is preferable for the amount of data stored in the buffer to correspond to at least the predetermined threshold amount of time. In this respect, if the predetermined threshold is set at 3 seconds, the buffer is operable to store data corresponding to 3 or more seconds of detected sound.

According to an example the voice trigger validator may further comprise a voice trigger detector. The voice trigger detector may be operable to detect the voice trigger event. When a voice trigger event is detected, the voice trigger detector is operable to search the data stored in the buffer to determine whether a start-of-speech event occurred within the predetermined threshold amount of time before occurrence of the voice trigger event. If the start-of-speech event occurred within the threshold amount of time, the voice trigger event is validated as a voice trigger. If the start-of-speech event did not occur within the threshold amount of time, the voice trigger event may be ignored or invalidated as a voice trigger. Further, when the voice trigger event is validated as a voice trigger, a validation signal may be output from the voice trigger detector or the voice trigger may be forwarded as an output to indicate a validated voice trigger. When the voice trigger event is invalidated as a voice trigger, an invalidation signal may be output from the voice trigger detector or no signal at all may be output.

In an example, the voice trigger validator may further comprise a memory operable to store each voice trigger event as either validated or invalidated. Storing the voice trigger events as either validated or invalidated may provide a useful database of voice trigger events, from which the voice trigger validator is able to learn in order to further improve validation accuracy. For example, a validated voice trigger event may subsequently be invalidated based on other criteria. A voice trigger event may include at least a part of a predetermined voice trigger word, phrase or sound. A start-of-speech event comprises a start of any detected speech pattern or a start of a speech pattern specific to a detected voice. Further, in an example, the voice trigger validator further comprises a timer, the timer being operable to start, upon detection of a start-of-speech event. The timer being further operable to time out when the time period exceeds the predetermined threshold, if no voice trigger event is detected. If a voice trigger event is detected before the timer times out, the voice trigger event may be validated as a voice trigger.

According to an example of a third aspect there is provided a voice trigger validation method. The voice trigger validation method comprises determining a time period between a voice trigger event and a start-of-speech event. When the time period exceeds a predetermined threshold, the voice trigger event is invalidated as a voice trigger. When the time period does not exceed the predetermined threshold, the voice trigger event is validated as a voice trigger.

In a further example, there is provided an audio signal processor, for receiving an audio input signal, comprising: a trigger phrase detector for detecting at least one feature indicative of a trigger phrase in the audio input signal and outputting a trigger signal if said at least one feature is detected; a start of speech detector for detecting at least one feature indicative of a start of speech in the audio input signal and outputting a speech signal if said start of speech feature is detected; and a decider for receiving the trigger signal and the speech signal and deciding if the trigger phrase is a valid trigger phrase, wherein the trigger signal is ignored by the decider if a time interval between the trigger signal and the speech signal is greater than a threshold amount of time.

Any of the above-described examples may be included in a speech recognition system. The speech recognition system may further comprise a function activation unit for activating idling and/or inactive functions of the speech recognition system, when the output trigger signal is not ignored. In a further example, the speech recognition system may comprise the acoustic sensor. The acoustic sensor may for example be one or more microphones.

According to an example of another aspect there is provided a computer program product, comprising a computer-readable tangible medium, and instructions for performing a method according to the previous aspect.

According to an example of another aspect there is provided a non-transitory computer readable storage medium having computer-executable instructions stored thereon that, when executed by processor circuitry, cause the processor circuitry to perform a method according to the previous aspect.

### BRIEF DESCRIPTION OF DRAWINGS

For a better understanding of the present disclosure, and to show how the same may be carried into effect, reference will now be made, by way of example only, to the accompanying drawings in which:

FIG. 1 is an audio signal processing circuit according to an example of the present disclosure;

FIG. 2 is an audio signal processing circuit according to an example of the present disclosure, further comprising a start of speech detection module;

FIG. 3 illustrates an example of detection of an input signal and the occurrence of a voice trigger;

FIG. 4 illustrates an alternative example of the detection of an input signal and the occurrence of a voice trigger;

FIG. 5 is a further example of the detection of an input signal and the occurrence of a voice trigger;

FIG. 6 is an example of an occurrence of a voice trigger that is subsequently ignored;

FIG. 7 is an example of the occurrence of a voice trigger which is not ignored;

FIG. 8 is an another example of the occurrence of a voice trigger which is subsequently ignored;

FIG. 9 is a further example of the occurrence of a voice trigger which is not subsequently ignored;

FIG. 10 is an example of a voice trigger validator according to the present disclosure;

FIG. 11 is an example of a voice trigger validator according to the present disclosure, further comprising a buffer, a voice trigger detector and a memory;

FIG. 12 is an exemplary embodiment of the audio signal processing according to the present disclosure;

FIG. 13 is an example of an audio signal processing circuit according to the present disclosure;

FIG. 14 is a flowchart illustrating the processing according to an example of the present disclosure;

FIG. 15 is another example of an audio processing circuit according to the present disclosure;

FIG. 16 is still another flowchart illustrating the processing according to an example of the present disclosure.

Throughout this description any features which are similar to features in other figures have been given the same reference numerals.

### DETAILED DESCRIPTION

The description below sets forth example audio signal processing functional units and/or circuitry including voice trigger validators according to this disclosure. Further examples and implementations will be apparent to those having ordinary skill in the art. Further, those having ordinary skill in the art will recognize that various equivalent techniques may be applied in lieu of, and/or in conjunction with, the examples discussed below, and all such equivalents should be deemed as being encompassed by the present disclosure.

The arrangements described herein can be implemented in a wide range of devices and systems. However, for ease of explanation, a non-limiting illustrative example will be described.

It is desirable to improve the performance of various forms of voice trigger technology. In accordance with one or more examples of the present disclosure, techniques are provided for reducing the number of “false positive” auditory triggers. In the present context these may include for example mid-sentence triggers, end of sentence triggers and non-speech triggers.

In accordance with the present disclosure, signals derived from a microphone of a device which may be in an (ALON) idle or standby mode and which is programmed to activate one or more functions associated with the device upon detection of a particular feature of speech, e.g. a trigger feature, are analysed in order that an occurrence of the trigger feature, which takes place a certain amount of time after the person speaking has started to speak, do not result in one or more additional functions, units or circuits of the device, such as a speech recognition processing unit, being activated.

In accordance with one or more examples auditory triggers occurring at a time interval from a detected start of speech which is greater than a threshold time interval, are deemed to be false positives and may thus be ignored. Thus, according to one or more examples the amount of time between a start of speech (the point at which speech begins, or the detection of speech first occurs) and the occurrence of a trigger phrase or parameter of a trigger phrase (the point at which at least a part of a trigger word or sound is spoken) may be used to eliminate so-called “false positive auditory triggers”. A reduction in falsely accepted triggers may therefore be achieved, leading to better voice trigger performance and better overall user experience.

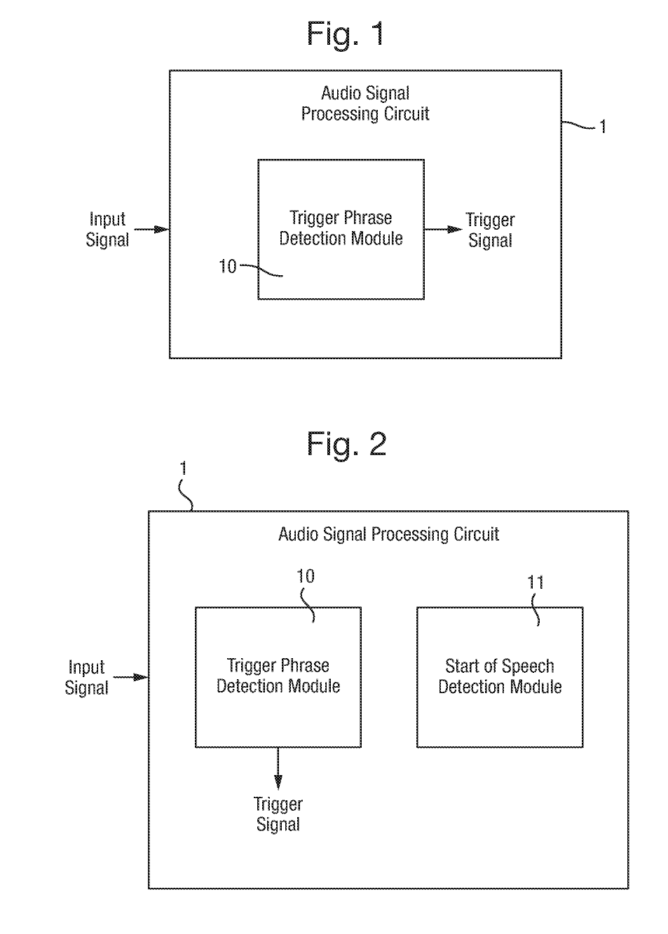

FIG. 1 illustrates an example of an audio signal processing circuit 1 according to an example of the present disclosure. The audio signal processing circuit 1 is operable to receive an input signal, which is derived from sound sensed by an acoustic sensor. The acoustic sensor may for example be a microphone. The audio signal processing circuit 1 comprises a trigger phrase detection module 10 for monitoring the input signal for at least one characteristic, parameter or feature and the like of a trigger phrase. The trigger phrase detection module 10 is further operable to output a trigger signal if at least one said feature of a trigger phrase is detected. According to one or more examples a trigger signal output by the trigger phrase detection module may be ignored if a time interval between the occurrence of the at least one feature of the trigger phrase and the occurrence of a feature indicative of a start of speech contained in the input signal is greater than a threshold amount of time or threshold time interval. The threshold amount of time may be predetermined and may be based on user input.

In accordance with the above described example the input signal may comprise one or more signals output from one or more acoustic sensors. The input signal may be received, at the audio signal processing circuit, in the form of a stream of digital data representative of real time, i.e. analogue, speech sensed by the acoustic sensor. The sound detected by the acoustic sensor may include one or more person's voices, producing specific voice patterns for each person, which are each distinguishable from one another. A trigger phrase may for example be a word or sound, known in advance to the trigger phrase detection module as being a voice command intended to activate idle functions of a device. A trigger phrase detection module may detect any feature, characteristic, parameter or the like of a trigger phrase. Such a feature may include a sound or a part of a word recognisable as a likely element of a trigger phrase. The trigger phrase detection module may then be operable to output a trigger signal if one of the known features is detected. In other words, if the trigger phrase detection module detects any part of a trigger phrase, a trigger signal may be output.

According to one or more examples, it is then determined if a time interval between an occurrence of the at least one feature of a trigger phrase and an occurrence of a feature indicative of a start of speech contained in the input signal is greater than a threshold amount of time. If the time interval is greater than the threshold, the trigger signal may be ignored. For example, the trigger signal is no longer recognised as a command to activate said functions.

If the time interval between the occurrence of the at least one feature of the trigger phrase and the occurrence of a feature indicative of a start of speech contained in the input signal is smaller than or equal to the threshold amount of time, the trigger signal is not ignored. In other words, the trigger phrase may simply be forwarded, or a separate command signal based on the trigger signal may be output, to cause or instruct activation of one or more functions, modules and/or circuits of a device incorporating the signal processing circuit.

FIG. 2 illustrates a further example of an audio signal processing circuit 1. The circuit further comprises a start of speech (start-of-speech) detection module 11 which is operable to detect a feature indicative of a start of speech, based on speech patterns in the input signal.

A start-of-speech comprises a start of any detected speech pattern or a start of a speech pattern specific to a detected voice. When multiple voices are detected, correspondingly multiple features indicative of a start of speech may be detected. The start of speech detection module 11 is able to receive the input signal, output for example from the acoustic sensor, and analyse the data in the input signal in order to detect patterns in the data indicating that one or more people have started speaking. In an example, the start of speech detection module 11 may be operable to detect speech patterns in the data, and, based on when those speech patterns first occurred, establish the start or starting time of the speech.

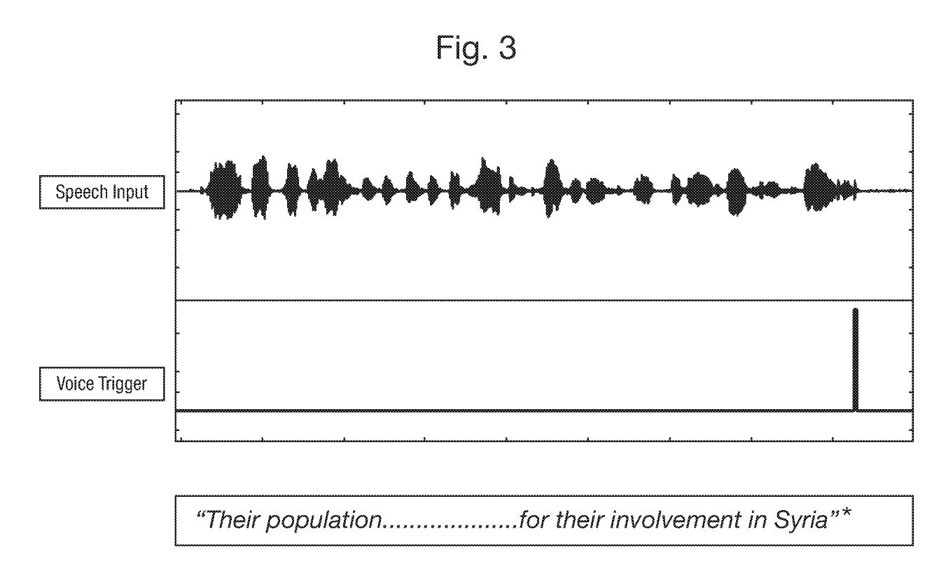

FIGS. 3, 4 and 5 illustrate examples of a speech input (receipt of an input signal) and the occurrence of a voice trigger. As illustrated in FIG. 3, a signal corresponding to the speech input is illustrated with the corresponding speech at the bottom of FIG. 3. A voice trigger is detected at the occurrence of the word “Syria”. In this case the intended voice trigger is the word “Siri” and the similarity between the two words means at least one feature, characteristic, parameter or the like of the trigger phrase is detected in the input signal. At this instance therefore a voice trigger is detected, for example by the trigger phrase detection module 10, which therefore outputs a trigger signal as a result of the occurrence of the feature. In accordance with this example, if a time interval between the occurrence of the feature of the voice trigger (the word “Syria”) and the occurrence of a feature indicative of the start of speech, contained in the input signal, (which in this case could be taken to have occurred at the start of the word “their”), is greater than the threshold amount of time, the trigger signal is ignored. In this context it is assumed that a trigger phrase will be spoken at the start of or towards the start of speech. Therefore, a voice trigger occurring sufficiently far from the start of speech is ignored or deemed invalid so as to eliminate voice triggers which are unlikely to be valid triggers.

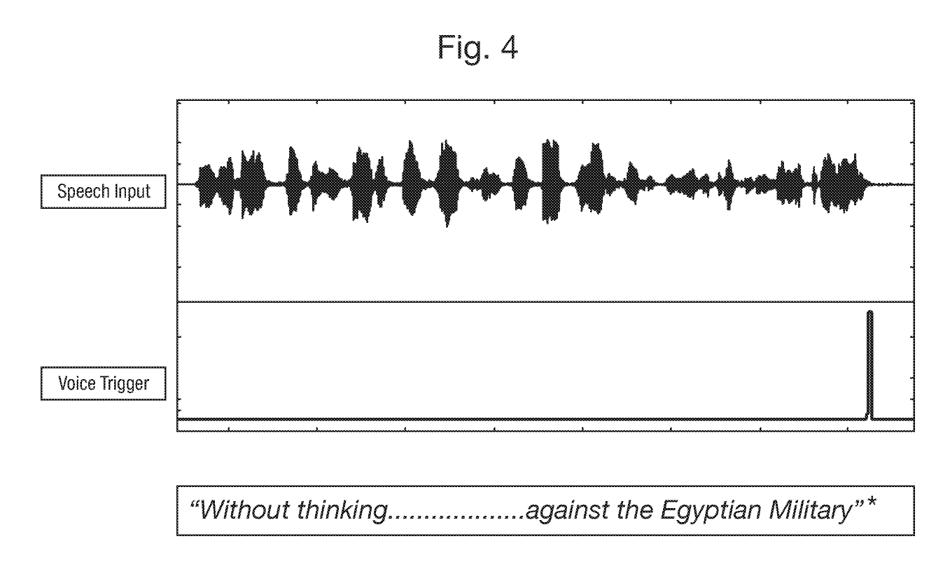

In a similar manner FIG. 4 illustrates another example of a voice trigger occurring towards the end of a speech input, or at least a significant distance from the start of speech, but the voice input at least includes at least one feature, characteristic, parameter or the like of a trigger phrase such that it is recognised as a voice trigger, wherein in this case the feature is the end of the word “military”. The “-ary” sound in the word “military” may in this case be mistaken for an occurrence of the trigger word “Siri”. In a similar manner to FIG. 3, the occurrence of the voice trigger is detected towards the end of a speech input and is thus unlikely to be an intended voice trigger. In accordance with the present disclosure the voice trigger occurring sufficiently far from the start of speech may be eliminated regardless of the nature of the feature of the trigger phrase recognised. For example an accurate trigger word or phrase may be spoken or an inaccurate feature of a trigger word or phrase may be spoken, both of which will be accepted as a feature of a trigger phrase, but ignored if occurring sufficiently far from the start of speech.

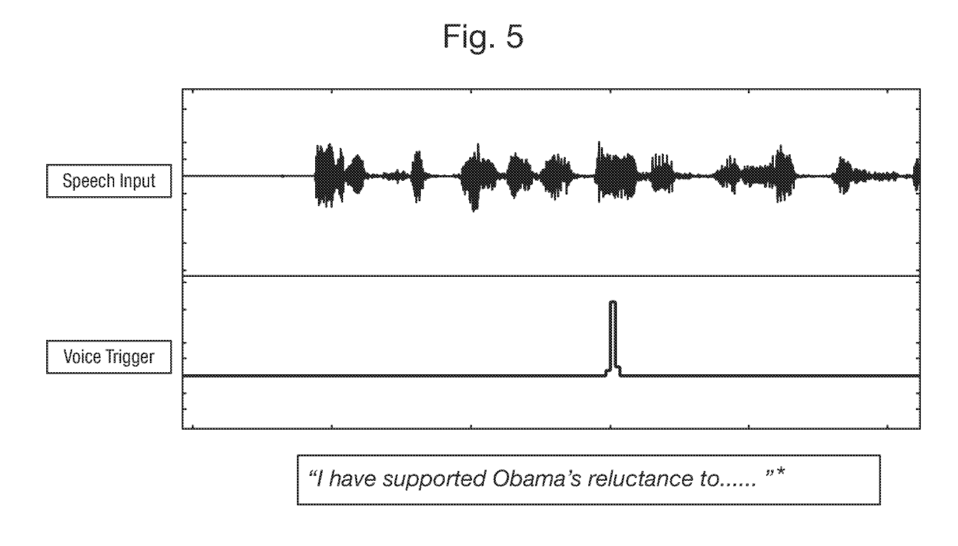

In accordance with another example, as illustrated in FIG. 5, a voice trigger may occur in the middle of a speech input (mid-sentence). Similarly to FIGS. 3 and 4 above, if the voice trigger is deemed to occur beyond the threshold amount of time from the start of speech, the voice trigger is ignored. Whereas if the voice trigger occurs sufficiently soon after the start of speech, the voice trigger is not ignored and may be deemed a valid voice trigger. In this case the feature of the trigger phrase is the end of one word and the start of the next word, for example “Obama's reluctance” resembling the word “Siri” as a false acceptance of a trigger word.

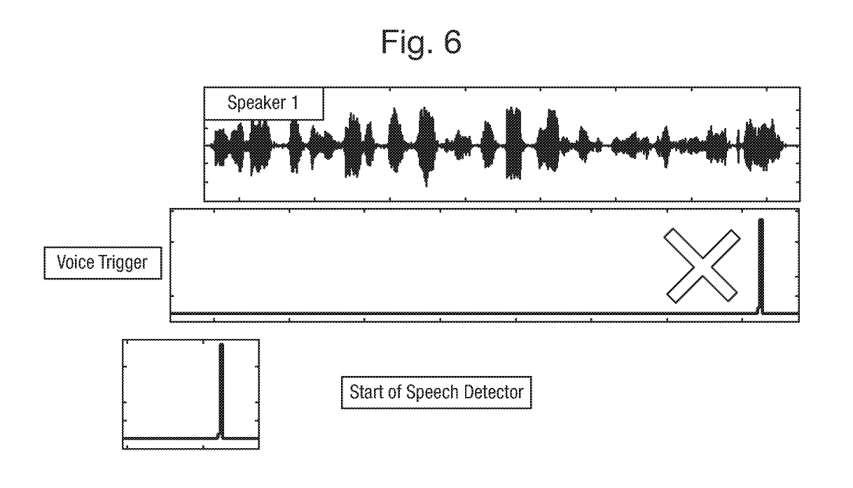

FIGS. 6, 7, 8 and 9, illustrate examples of different voice triggers either being ignored or not ignored, in other words validated or invalidated as voice triggers. FIG. 6 illustrates an example of a speech pattern of a person speaking along with the location of a voice trigger relative to the person's speech and the position of the start of speech detection wherein, in each case, time is progressing from left to right in the Figure. The voice trigger illustrated in FIG. 6 occurs after the threshold amount of time, between the start of speech detection and the voice trigger occurrence, has passed, such that the trigger signal is ignored or the voice trigger is invalidated. In this case it is deemed that the voice trigger occurs too far from the start of speech to be likely to be a valid voice trigger and is therefore disregarded.

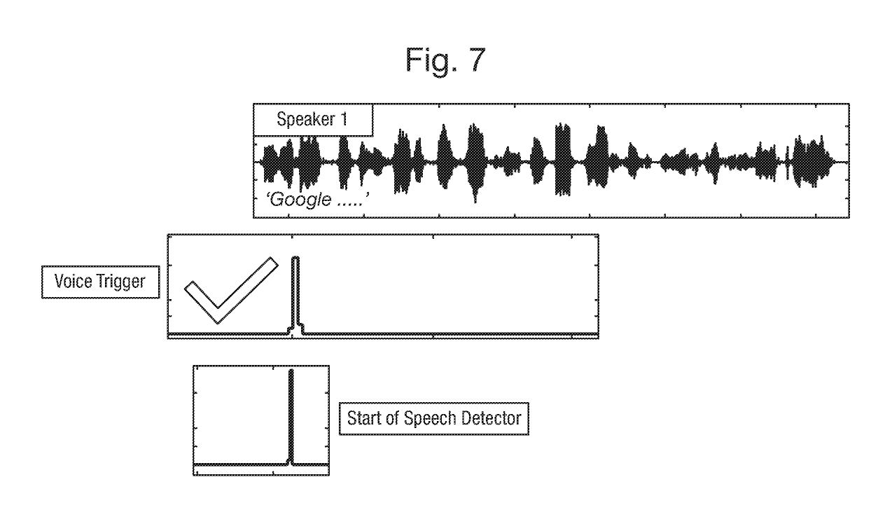

FIG. 7 illustrates a further example of the speech pattern of a person speaking (speaker), the location of a voice trigger relative to the speech pattern and the location of a start of speech detection. In this case the voice trigger occurs with a relatively small time interval (smaller than the threshold time) between the start of speech detection and the voice trigger occurrence such that the trigger signal is not ignored and is validated as a voice trigger. As illustrated in FIG. 7, a typical command of this sort may include the word “Google”, which may be the first word spoken by a person speaking thus causing the voice trigger and the start of speech to occur with a small or no time interval therebetween and, in this case, within the threshold amount of time.

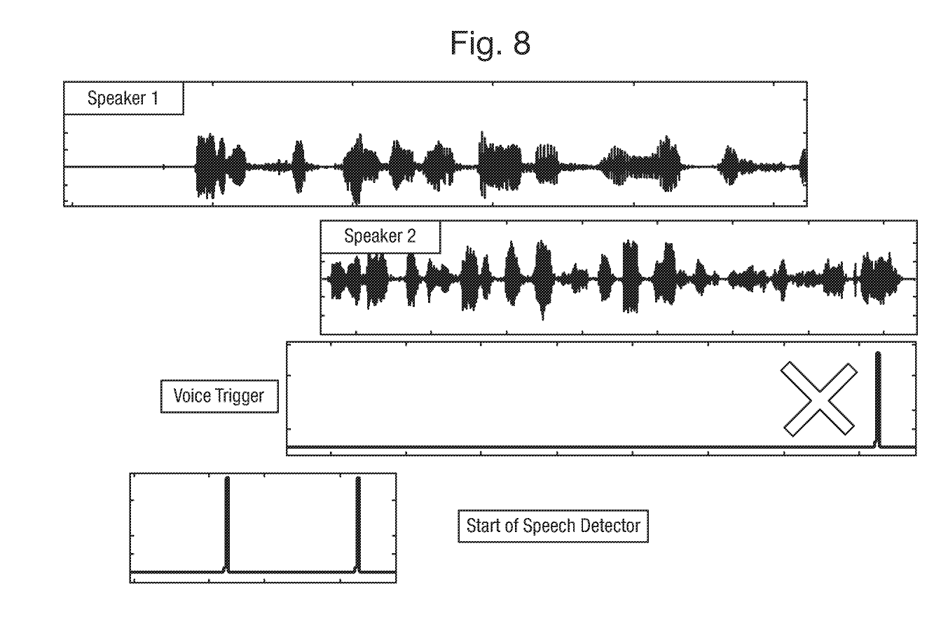

FIG. 8 illustrates an example including two separate persons speaking. In this case the different voice signals of persons 1 and 2 may be identifiable and distinguishable from each other such that a start of speech detection (corresponding to a start of speech event) occurs at the start of speech for each of the individual persons speaking. As illustrated in FIG. 8 this would result in two separate start of speech occurrences. In this case a voice trigger is detected towards the end of a speech pattern of person 2. This voice trigger occurrence occurs with a large time interval between the start of speech detection and the voice trigger occurrence, such that the trigger signal is then ignored.

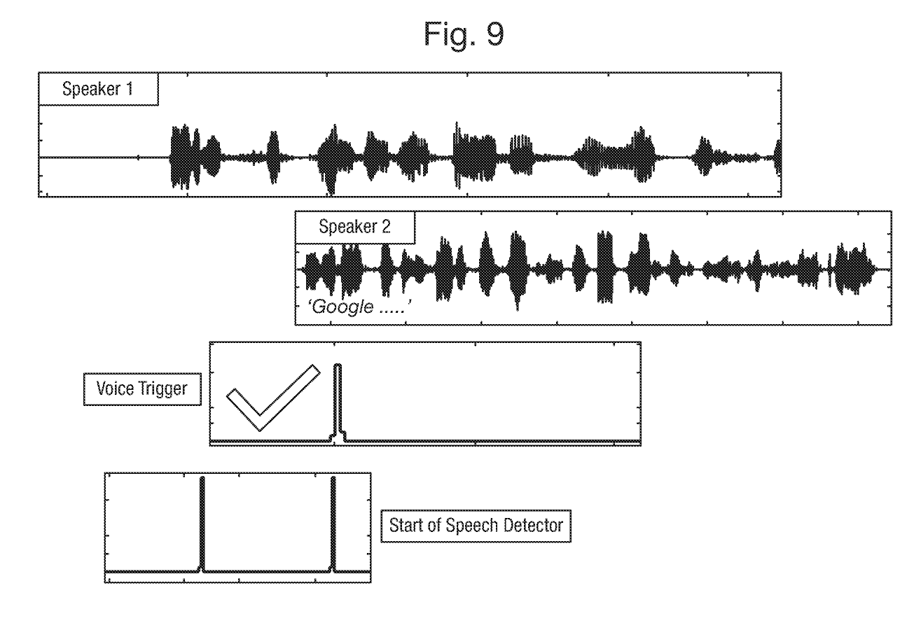

FIG. 9, on the other hand, illustrates an example in which both persons 1 and 2 are speaking however in this case a voice trigger occurs at a smaller time interval from the start of speech of person 2. In accordance with one example the time interval may be calculated from any start of speech detected to any voice trigger detected. However in an alternative example it may be verified whether the start of speech detected relates to a speech of a given person speaking, for example person 1, and the voice trigger is spoken by the same person. In the example illustrated in FIG. 9 the start of speech detector detects the start of speech of person 2 and shortly thereafter, i.e., within a time interval not exceeding the threshold amount of time, a voice trigger is detected, which is spoken by person 2 also. Therefore, in this example the trigger signal is not ignored and the voice trigger may be validated. In the event a trigger signal is ignored or a voice trigger is invalidated, an invalidation signal may be output reflecting this. Alternatively if a trigger signal is not ignored or the trigger signal is validated, a validation signal may be output reflecting this.

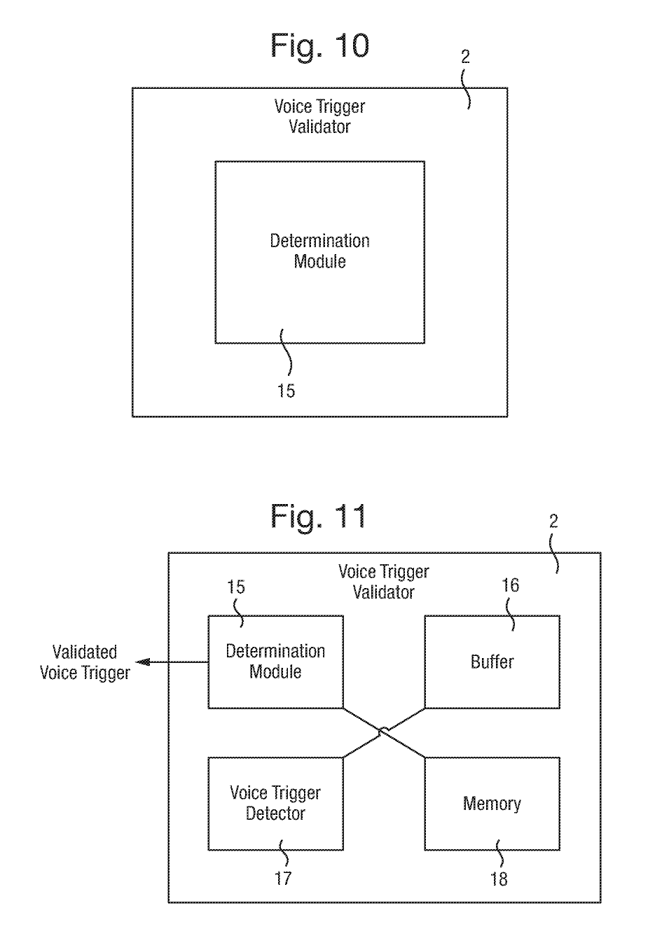

FIG. 10 illustrates a voice trigger validator according to an example of the present disclosure. The voice trigger validator 2 may comprise a determination module 15 operable to determine a time period or delay between a voice trigger event and a start of speech event. When the time period or delay exceeds a predetermined or user defined threshold or value, the voice trigger event is invalidated as a voice trigger and, when the time period does not exceed the predetermined threshold, the voice trigger event is validated as a voice trigger.

As described above, a voice trigger may be validated or invalidated on the basis of the length of the determined time period. A validated voice trigger may for example be output to perform further commands such as activating otherwise inactive or idling functions, modules and/or circuits of the product. An invalid voice trigger may either be ignored or an invalidation signal may be output. An invalidated voice trigger will not be used as a command to activate otherwise inactive or idling functions, modules and/or circuits of the device.

Voice triggers tend to be used as a first word of a sentence or when a person starts speaking. Therefore, according to the present example, a trigger occurring anywhere except at or near the start of speech is deemed not to be a valid trigger. This is determined by setting a predetermined threshold after which a voice trigger is ignored. In other words, after a specific amount of time, any subsequent voice command is deemed to be invalid and is disregarded.

The threshold is a predetermined and/or user defined maximum allowable amount of time or delay, between a detected start-of-speech and a detected voice trigger, in order for the voice trigger to be considered valid.

FIG. 11 illustrates a further embodiment of an example of a voice trigger validator 2, as described above, further comprising a buffer 16, a voice trigger detector 17, and/or a memory 18. A voice trigger validator 2 according to the present disclosure may include any one or more of the disclosed features.

The buffer 16 is operable to store a predetermined amount of data derived from sound received by a sound detector. Upon detection of the voice trigger event as received sound, the stored data may be analysed to determine whether a start-of-speech event was detected. The buffer 16 may be configured to receive information derived from the detected sound as a digital data stream and to store this data, corresponding to the specific amount of the detected sound. Therefore the buffer 16 may for example be a circular buffer that stores data corresponding to the most recent n seconds of detected sound and, upon detection of a voice trigger event, the data corresponding to those n seconds of detected sound may be searched for an occurrence of a start-of-speech event. In a further example, the buffer 16 may store data corresponding to the most recent n seconds of detected sound, but data corresponding to the most recent m seconds only is searched (where m<n). It is preferable for the amount of data stored in the buffer to correspond to at least the threshold amount of time or delay. In this respect, if the threshold is set at x seconds, the buffer is operable to store data corresponding to x or more seconds of detected sound.

According to an example the voice trigger validator 2 may further comprise a voice trigger detector 17. The voice trigger detector 17 is operable to detect the voice trigger event. When a voice trigger event is detected, the voice trigger detector 17 may further be operable to analyse the data stored in the buffer 16 to determine whether a start-of-speech event occurred within the threshold amount of time before occurrence of the voice trigger event. When the start-of-speech event occurred within the threshold amount of time, the voice trigger event is validated as a voice trigger. When the start-of-speech event did not occur within the threshold amount of time, the voice trigger event may be invalidated as a voice trigger. Further, when the voice trigger event is validated as a voice trigger, a validation signal may be output from the voice trigger detector or the voice trigger may be forwarded as an output to indicate a validated voice trigger. When the voice trigger event is invalidated as a voice trigger, an invalidation signal may be output from the voice trigger detector or no signal at all may be output.

In an example, the voice trigger validator 2 may further comprise a memory 18 operable to store data corresponding to each voice trigger event along with an indication of whether the event is deemed as validated or invalidated. Storing the voice trigger events as either validated or invalidated may provide a useful database of voice trigger events, from which the voice trigger validator 2 is able to learn in order to further improve validation accuracy. For example, a validated voice trigger event may subsequently be invalidated based on other criteria. A voice trigger event may include at least a part of a predetermined voice trigger word, phrase or sound. A start-of-speech event comprises a start of any detected speech pattern or a start of a speech pattern specific to a detected voice.

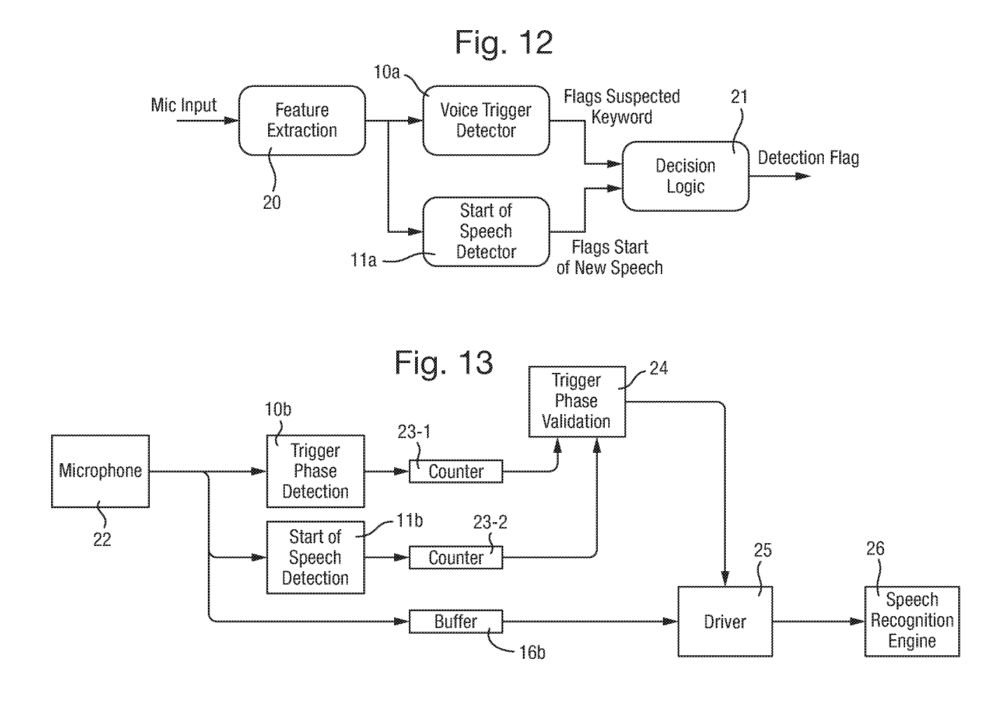

FIG. 12 illustrates a further embodiment of an example of the processing carried out in line with the examples described. As illustrated, a sound detector/receiver, such as a microphone, detects sound such as the voice of a user. The detected sound may be converted into signal data for processing. The data may then undergo feature extraction to reduce the processing burden on subsequent processing steps. Feature extraction may be carried out in a number of ways, some example options include log mels, PNNCs (Power-Normalized Cepstral Coefficients), MFCCs (Mel-frequency cepstral coefficients), etc. The data is then passed to a voice trigger detector 10a and a start of speech detector 11a. The voice trigger detector 10a may be a functional unit, module and or circuitry operable to detect a particular keyword or key phrase and output a flag or similar indicating the detection of such a keyword or key phrase. The start of speech detector 11a may be a functional unit, module and/or circuitry operable to detect data corresponding to sounds indicating speech and to determine the start time of the speech, so as to, in essence, detect the start of speech. The start of speech detector 11a may then output a flag indicating the detection. The start of speech detector 11a may for example not determine the time corresponding to the start of speech and may simply output an indication that the detection has occurred. The outputs from the voice trigger detector 10a and the start of speech detector 11a may then be fed into a decision logic 21. The decision logic 21 is operable, based on the outputs of the detectors 10a and 11a, to determine whether a time period between a detected voice trigger and a detected start of speech exceeds a threshold amount of time or delay. On the basis of the determination, the voice trigger may be invalidated or ignored when the time period exceeds the threshold. Alternatively, when the time period does not exceed the threshold, the voice trigger may be validated or accepted. A voice trigger that is validated or accepted is then allowed to proceed as a command for a function, for example activation of a device, module and/or circuit or idling functions of a device.

In an example, a start of speech detector 11a may be running concurrently with the voice trigger detector 10a. In another example, the detectors may share the same feature extraction to reduce the processing burden. The start of speech detector 11a may be based on speech segmentation algorithms. The start of speech detector 11a may produce spikes, as an example of an output signal, whenever it detects that a new speaker (person speaking) started speaking. This information will be used with that of the voice trigger detector 10a (which spikes whenever the trigger is detected). This use of combined information may serve to eliminate several false triggers reducing the overall number of false triggers.

In one example, trigger detection and start of speech detection is set to “always on” (ALON). In an “always on” configuration, a device may be set to carry out passive listening. Passive listening involves listening for a particular event, such as a trigger phrase or a start of speech, but no other speech or sound recognition is carried out.

FIG. 13 illustrates a further example of start of speech detection 11b being used in conjunction with trigger phrase detection 10b for the purpose of reducing the number of false triggers. False triggers occur when a word or phrase is deemed to be a trigger, but is not in fact the trigger word or phrase. The number of false triggers can be reduced by eliminating unlikely trigger candidates from consideration, based on a different criterion. In the present example, the criterion of time between detection of a start of speech and detection of a trigger word (trigger word or phrase) is used to eliminate likely false triggers. That is to say, trigger words are likely to be spoken as a first word or at least near the point at which a user starts talking. Therefore, trigger words occurring further away from a start of speech (when a user starts speaking) may be eliminated as false triggers.

In accordance with the example of FIG. 13, the microphone 22 may be set to be in an “always on” (ALON) mode and sending audio data, corresponding to detected sound, to the trigger phrase detection block 10b, the start of speech detection block 11b and the buffer 16b. Once the start of speech is detected by the speech detection block 11b, a counter (timer) 23-1 is started. The counter 23-1 will time out if no trigger phrase is detected within a certain expected (predetermined or user-defined) period. Similarly, once a trigger is detected by the trigger phrase detection block 11b, a counter 23-2 is started. The counter 23-2 will time out if no start of speech is detected within a certain expected (predetermined or user-defined) period. If a trigger follows the start of speech, or vice versa, without the expected period then the trigger phrase validation step would then be activated and based on the counters 23-1 and 23-2. The trigger phrase validation block 24 may then indicate to a pass gate (driver) 25 that a trigger phrase has occurred, the pass gate 25 then in turn may allow the buffered trigger phrase to pass, along with the associated audio data, to the speech recognition engine 26. The speech recognition engine 26 is operable to carry out further functions based on instructions spoken by a user, contained in the audio data. The latency of the signal from the microphone 22 through the respective trigger phrase detection block 10b, the start of speech detection block 11b and the buffer 16b paths may be taken into account of, as will be understood by those skilled in the art, such that the pass gate is “opened” at, and for, the appropriate time so as to allow the ‘validated’ data derived from microphone to be passed on for further processing.

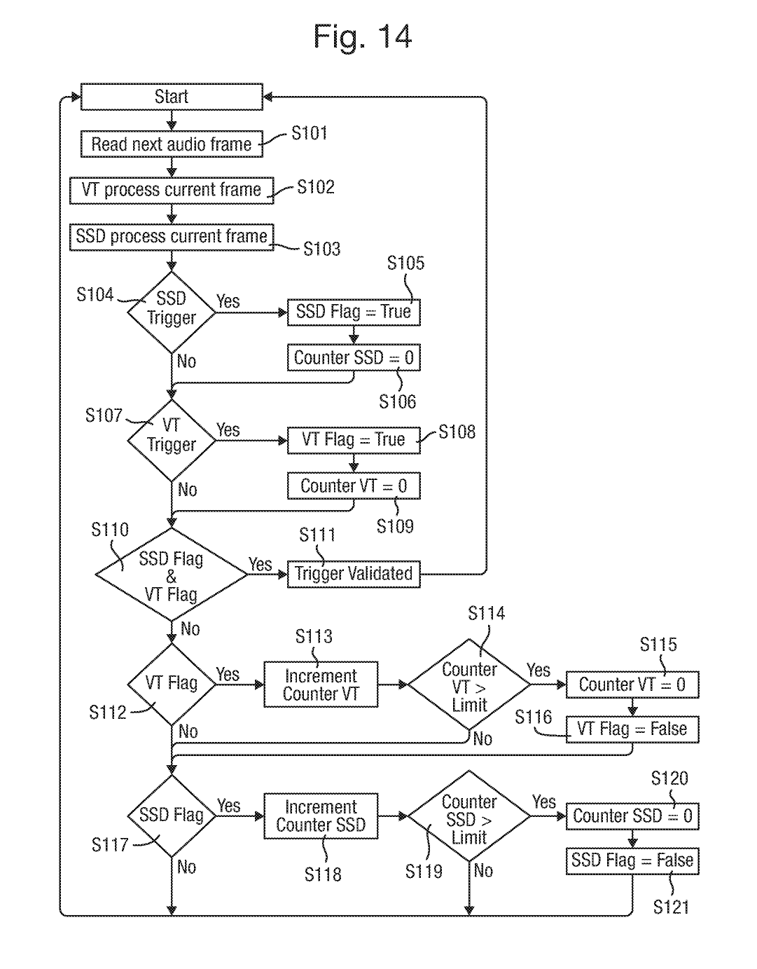

In accordance with the above example, the flow diagram illustrated in FIG. 14 details the steps involved. In accordance with the method depicted in FIG. 14, in a first step an audio frame, including an amount of audio data, is read S101. Next, the voice trigger processing is carried out on the audio frame S102 and the start of speech processing is carried out on the audio frame as well S103. Although S103 is shown in FIG. 14 as occurring after S102, steps S102 and S103 may be reversed in order or carried out in parallel. The process then moves on to determining whether a start of speech event has occurred S104 (SSD Trigger->Yes/No). If a start of speech event has occurred (SSD Trigger->Yes), the process moves on to S105, where a start of speech flag is activated, set to true or similar, to indicate the occurrence of the start of speech event. A start of speech counter is then started S106 and the process continues to S107. If a start of speech event has not occurred at S104 (SSD Trigger->No), then the processing continues directly to S107. At S107, the process proceeds to determine whether a voice trigger has occurred (VT Trigger->Yes/No). If a voice trigger has occurred (VT Trigger->Yes), the process moves on to S108, where a voice trigger (VT) flag is activated, set to true or similar, to indicate the occurrence of the voice trigger. A voice trigger (VT) counter is then started S109 and the process continues to S110. If a voice trigger event has not occurred at S107 (VT Trigger->No), then the processing continues directly to S110. At step S110 it is determined whether both the SSD flag and the VT flag are active, set to true or similar. If both flags are active, the trigger is validated S111 and the processing continues as described in relation to FIG. 13. The process shown in FIG. 14 returns to the start to await a next audio frame to be read.

If at least one of the VT flag and the SSD flag are not set, the processing continues to S112. At S112, it is determined whether the VT flag is active (VT Flag->Yes/No). If the VT flag is active (VT Flag->Yes) the processing continues to S113, where the VT counter is checked. It is determined whether the time on the VT counter is greater than a set limit (over a threshold) S114 and, if the time is greater than the limit, the counter is reset S115 and the VT flag is deactivated, set to false or similar S116. The processing then continues to step S117. If the check is negative at either of S112 (VT Flag->No) or S114 (time not greater than limit), the processing continues directly to S117.

At S117, it is determined whether the SSD flag is active (SSD Flag->Yes/No). If the SSD flag is active (SSD Flag->Yes) the processing continues to S118, where the SSD counter is checked. It is determined whether the time on the SSD counter is greater than a set limit (over a threshold) S119 and, if the time is greater than the limit, the counter is reset S120 and the SSD flag is deactivated, set to false or similar S121. The processing then returns to the start. If the check is negative at either of S117 (SSD Flag->No) or S119 (time not greater than limit), the processing also returns to the start.

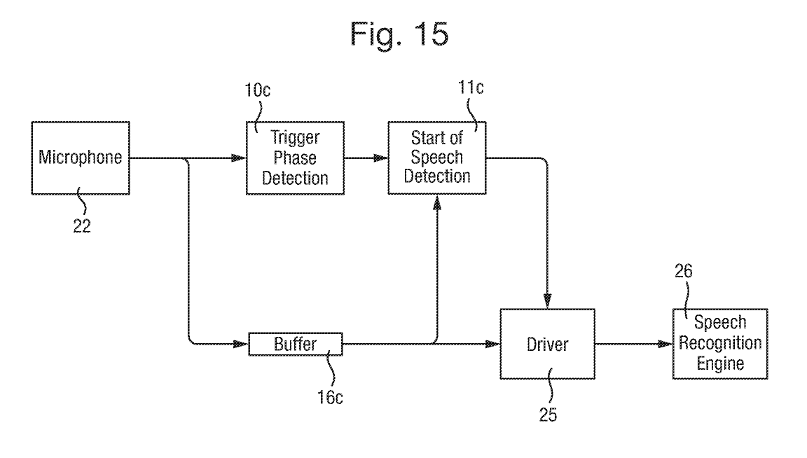

FIG. 15 illustrates another possible implementation, according to an example. The main difference, with respect to the example of FIG. 13, is that the start of speech detection block is not always on, but is only initiated once the trigger is detected.

In accordance with the example of FIG. 15, the microphone 22 is always on and sending audio to the trigger phrase detection block 10c and the buffer 16c. Once the trigger is detected by the trigger phrase detection block 10c it may signal to the start of speech detection block 10c to validate that the trigger is indeed at or near the start of speech. The start of speech detection block 10c may process the buffered audio data, searching for the start of speech. The start of speech detection block 10c may then act as the trigger phrase validator. If it determines that the trigger did occur at or near the start of speech it may signal the driver 25 to stream the buffered audio to the speech recognition engine 26. If not, the trigger phrase may be rejected as a false trigger.

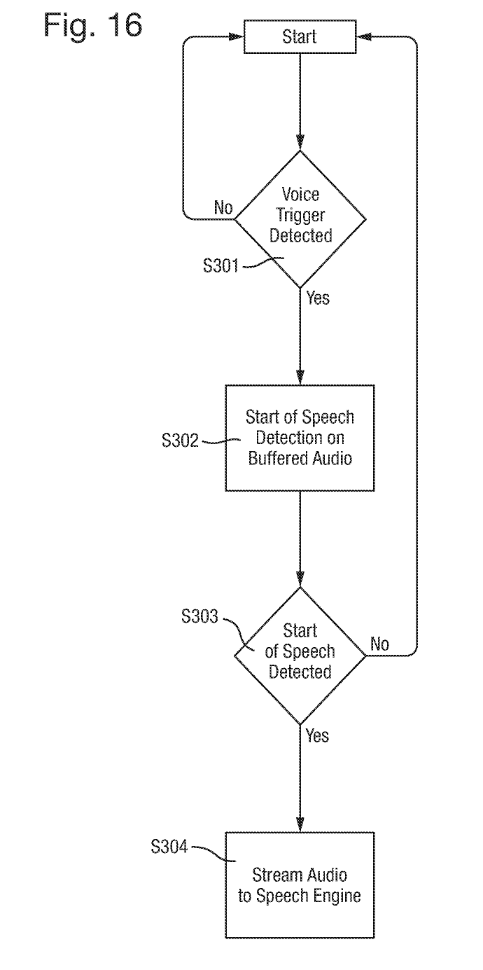

In accordance with the above example, the flow diagram illustrated in FIG. 16 details the steps involved. In accordance with the method depicted in FIG. 16, it is determined whether a voice trigger is detected S301. When a voice trigger is detected, the received data, corresponding to sound detected by the microphone 22, which is buffered in the buffer 16c is searched for the presence of a start of speech S302. If a start of speech is present (detected) in the buffered data S303, the audio signal detected by the microphone 22 is streamed S304 to the speech recognition engine 26. If no start of speech is detected in the buffered data, the processing returns to the start to determine whether a voice trigger is detected.

Any of the above-described examples may be included in a telephone, mobile telephone, portable or wearable device or any other device using voice activation. It will be appreciated that features of any of the above aspects and examples may be provided in any combination with the features of any other of the above aspects and examples. Examples may further be implemented in a host device, especially a portable and/or battery powered host device such as a mobile computing device for example a voice-controlled home assistant, mobile telephone or smartphone.

The skilled person will recognise that some aspects of the above-described apparatuses and methods may be embodied as processor control code, for example on a non-volatile carrier medium such as a disk, CD- or DVD-ROM, programmed memory such as read only memory (Firmware), or on a data carrier such as an optical or electrical signal carrier. For many applications examples of the invention will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the examples may also be implemented using code running on a field-(re)programmable analogue array or similar device in order to configure analogue hardware.

Note that as used herein the term unit or module shall be used to refer to a functional unit or block which may be implemented at least partly by dedicated hardware components such as custom defined circuitry and/or at least partly be implemented by one or more software processors or appropriate code running on a suitable general purpose processor or the like. A unit may itself comprise other units, modules or functional units. A unit may be provided by multiple components or sub-units which need not be co-located and could be provided on different integrated circuits and/or running on different processors.

Examples may be implemented in a host device, especially a portable and/or battery powered host device such as a mobile computing device for example a laptop or tablet computer, a games console, a remote control device, a home automation controller or a domestic appliance including a smart home device a domestic temperature or lighting control system, a toy, a machine such as a robot, an audio player, a video player, or a mobile telephone for example a smartphone.

It should be noted that the above-mentioned examples illustrate rather than limit the disclosure, and that those skilled in the art will be able to design many alternative configurations without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. An audio signal processing circuit for receiving an input signal derived from sound sensed by an acoustic sensor, the audio signal processing circuit comprising:
a trigger phrase detection module for monitoring the input signal for at least one feature of a trigger phrase and outputting a trigger signal if one said feature is detected; wherein
the trigger signal is ignored if a time interval between an occurrence of the at least one feature and an occurrence of a feature indicative of a start of speech contained in the input signal is greater than a threshold amount of time.

2. The audio signal processing circuit according to claim 1, further comprising:
a start of speech detection module operable to detect one said feature indicative of a start of speech, based on speech patterns in the input signal.

3. The audio signal processing circuit according to claim 1, wherein
the trigger signal is not ignored if the time interval between the occurrence of the at least one feature and the occurrence of the feature indicative of a start of speech contained in the input signal is smaller in length than or equal in length to a threshold amount of time.

4. The audio signal processing circuit according to claim 1, wherein
the feature of a trigger phrase includes at least a part of a predetermined voice trigger word, phrase or sound.

5. A voice trigger validator comprising:
a determination module operable to determine a time period between a voice trigger event and a start-of-speech event; wherein, when the time period exceeds a predetermined threshold, the voice trigger event is invalidated as a voice trigger and, when the time period does not exceed the predetermined threshold, the voice trigger event is validated as a voice trigger.

6. The voice trigger validator according to claim 5, further comprising:
a buffer operable to store a predetermined amount of data derived from sound received by a sound detector; wherein
upon detection of the voice trigger event, the stored data is searched to determine whether a start-of-speech event was detected.

7. The voice trigger validator according to claim 6, wherein
the predetermined amount of data is sufficient to store received sound, as data, for at least an amount of time corresponding to the predetermined threshold.

8. The voice trigger validator according to claim 6, further comprising:
a voice trigger detector operable to detect the voice trigger event, wherein
when a voice trigger event is detected, the voice trigger detector is operable to search the data stored in the buffer to determine whether a start-of-speech event occurred within the predetermined threshold amount of time before occurrence of the voice trigger event, and wherein,
when the start-of-speech event occurred within the threshold amount of time, validating the voice trigger event as a voice trigger, and
when the start-of-speech event did not occur within the threshold amount of time, invalidating the voice trigger event as a voice trigger.

9. The voice trigger validator according to claim 8, wherein
when the voice trigger event is validated as a voice trigger, a validation signal is output from the voice trigger detector, and
when the voice trigger event is invalidated as a voice trigger, a invalidation signal is output from the voice trigger detector.

10. The voice trigger validator according to claim 6, further comprising:
a memory operable to store each voice trigger event as either validated or invalidated.

11. The voice trigger validator according to claim 6, wherein
the voice trigger event includes at least a part of a predetermined voice trigger word, phrase or sound, and wherein
the start-of-speech event comprises a start of any detected speech pattern or a start of a speech pattern specific to a detected voice.

12. (canceled)

13. The voice trigger validator according to claim 6, further comprising:
a timer operable to start upon detection of a start-of-speech event and to time out when the time period exceeds the predetermined threshold, if no voice trigger event is detected, wherein
if a voice trigger event is detected before the timer times out, the voice trigger event is validated as a voice trigger.

14. An automatic speech recognition system comprising an audio signal processing circuit for receiving an input signal derived from sound sensed by an acoustic sensor, the audio signal processing circuit comprising:
a trigger phrase detection module for monitoring the input signal for at least one feature of a trigger phrase and outputting a trigger signal if one said feature is detected; wherein
the trigger signal is ignored if a time interval between an occurrence of the at least one feature and an occurrence of a feature indicative of a start of speech contained in the input signal is greater than a threshold amount of time.

15. The speech recognition system according to claim 14, further comprising:
a function activation unit for activating idling functions of the speech recognition system, when the output trigger signal is not ignored.

16. A signal processing circuit according to claim 1 in the form of a single integrated circuit.

17. A device comprising a signal processing circuit according to claim 1 wherein the device comprises a mobile telephone, an audio player, a video player, a mobile computing platform, a games device, a remote controller device, a toy, a machine, or a home automation controller, a domestic appliance or a smart home device.

18. (canceled)

19. (canceled)

20. A voice trigger validation method comprising:
determining a time period between a voice trigger event and a start-of-speech event; wherein, when the time period exceeds a predetermined threshold, the voice trigger event is invalidated as a voice trigger and, when the time period does not exceed the predetermined threshold, the voice trigger event is validated as a voice trigger.

21. An automatic speech recognition system comprising a voice trigger validator, the voice trigger validator comprising:
a determination module operable to determine a time period between a voice trigger event and a start-of-speech event; wherein, when the time period exceeds a predetermined threshold, the voice trigger event is invalidated as a voice trigger and, when the time period does not exceed the predetermined threshold, the voice trigger event is validated as a voice trigger.

22. A device comprising a voice trigger validator according to claim 5, wherein the device comprises a mobile telephone, an audio player, a video player, a mobile computing platform, a games device, a remote controller device, a toy, a machine, or a home automation controller, a domestic appliance or a smart home device.
